(19) United States
(12) Patent Application Publication
(10) Pub. No.: US 2013/0018941 A1
(43) Pub. Date: Jan. 17, 2013

(54) TECHNIQUES FOR PRESENTING EDUCATIONAL MATERIAL ONLINE

(71) Applicant: Dan Olaru, Aurora (CA)

(72) Inventor: Dan Olaru, Aurora (CA)

(73) Assignee: Beacon Communications Services, LLC, Melrose, MA (US)

(21) Appl. No.: 13/544,233

(22) Filed: Jul. 9, 2012

Related U.S. Application Data
(60) Provisional application No. 61/506,676, filed on Jul. 12, 2011.

(51) Int. Cl. G06F 15/16

(52) U.S. Cl. 709/203

(57) ABSTRACT

Embodiments of the invention provide techniques for verifying that an attendee of an online educational presentation views material that is presented. In some embodiments, a server computer may instruct an attendee's client computer to present verification information to the attendee which the attendee is to acknowledge. The verification information may, for example, comprise one or more codes, and may be presented at a point in time which is difficult for an attendee to predict. An indication whether the attendee acknowledged the verification information during the time it was presented may be stored, allowing the organizer of an online presentation to determine whether each attendee paid attention to the content presented.

### RELATED APPLICATION

This application claims priority under 35 U.S.C. §119(e) to U.S. Provisional Application Ser. No. 61/506,676, filed on Jul. 12, 2011, entitled “CE CODES,” the entirety of which is incorporated herein by reference.

### BACKGROUND

Online educational presentations enable instructional content to be conveyed in an environment wherein the presenter (e.g., a teacher) and one or more attendees (e.g., students) may be separated by time and/or space. Typically, various networking technologies (e.g., the Internet and/or World Wide Web, and/or other networking technologies) are used to communicate content from at least one server computer to one or more client computers each executing a browser and/or native application enabling one or more attendees to view the material. Because presentations are delivered online rather than face-to-face, the presenter and attendees need not travel to the same location for the presentation, and so online delivery affords opportunities to save the time and expense typically associated with travel. Additionally, online delivery often affords attendees flexibility with regard to when the material is viewed, since they often may do so at any time after it is made available.

### SUMMARY

The inventors have appreciated that in some settings, it may be desirable to verify that attendees of an online educational presentation actually pay attention to the material that is presented. In this respect, online educational events are often facilitated by organizations which wish to disseminate important information (e.g., to employees, such as to train the employees on the organization's products and services), and/or to offer professional credit (e.g., continual learning credit) in exchange for attendance. While the online delivery model affords various advantages, it also presents difficulties with regard to confirming that attendees actually see the content that is presented. For example, conventionally, an attendee of an online educational presentation could start a presentation on his/her computer, walk away from the computer without actually viewing the material that is presented, and get “credit” for having attended the presentation anyway.

Some embodiments of the invention provide techniques for verifying that an attendee views educational material presented online. In some embodiments, a server computer may instruct an attendee's client computer to present verification information to the attendee during an online presentation, along with a request that the attendee acknowledge the verification information. The verification information may, for example, comprise one or more codes which may be specified by an administrator, and the attendee may be asked to acknowledge the codes by typing them in, so as to verify that he/she was paying attention at the time they were presented. Verification information may, for example, be presented at a point in time which is difficult for an attendee to predict, and may remain on the screen for only a limited time interval if the attendee does not acknowledge it. The client computer and/or server computer may record an indication whether the attendee acknowledged the verification information during the time it was presented, and may generate one or more reports based on the indication. As such, embodiments of the invention may help the organizer of an online presentation determine whether each attendee paid attention to the content which was presented.

The foregoing description relates to only one example implementation of some aspects of the invention. Numerous variations on this example implementation are possible, and some of these variations are described herein. As such, the foregoing represents a non-limiting summary of some embodiments of the invention. Other embodiments may be reflected in the attached claim listing.

### BRIEF DESCRIPTION OF DRAWINGS

The accompanying drawings are not intended to be drawn to scale. In the drawings, each identical or nearly identical component as illustrated in various figures is represented by a like numeral. For purposes of clarity, not every component may be labeled in every drawing. In the drawings:

FIG. 1 is a block diagram depicting an example system for determining whether an attendee views content included in an online educational presentation, in accordance with some embodiments of the invention;

FIG. 2 is a time sequence diagram depicting an example technique by which a server computer may instruct a client computer to present verification information to an attendee, in accordance with some embodiments of the invention;

FIG. 3 is a time sequence diagram depicting an example alternative technique by which a server computer may instruct a client computer to present verification information to an attendee, in accordance with some embodiments of the invention;

FIG. 4 is a flowchart depicting an example technique for determining whether an attendee acknowledges verification information included in an online educational presentation, in accordance with some embodiments of the invention;

FIG. 5 is a block diagram depicting an example computer with which aspects of the invention may be implemented.

### DETAILED DESCRIPTION

In some embodiments of the invention, techniques are provided for verifying that the attendees of an online educational presentation pay attention to the material that is presented. Some embodiments of the invention may, for example, be implemented in a client-server computing environment in which one or more server computers issue instructions to an attendee's client computer. The one or more server computers may instruct an attendee's client computer to present verification information to the attendee during an online educational presentation, along with a request that the attendee acknowledge the verification information in a specified way. The verification information may, for example, comprise one or more codes, which may be randomly generated, specified by an administrator, and/or established in any other suitable manner. When codes are presented to an attendee, he/she may be asked to acknowledge them by, for example, typing in the codes, clicking on them, and/or taking any other suitable action. In some embodiments, the point(s) in time at which verification information is presented to the attendee may be difficult for the attendee to predict, so that he/she cannot “game” the system by determining the times at which the verification information is to be shown, and then viewing the online educational presentation only at those times. For example, verification information may be presented at a point in time which is determined randomly, or at a point in time which is determined based in part on some random element (e.g., at a random point in time within a time interval that is set by an administrator). In some embodiments, the verification information may only remain on an attendee's computer screen for a predefined, limited time if not acknowledged by the attendee. A record may be kept of whether each attendee acknowledged the verification information presented to him/her, and this record be used to generate reports detailing whether each attendee paid attention to the material that was presented.

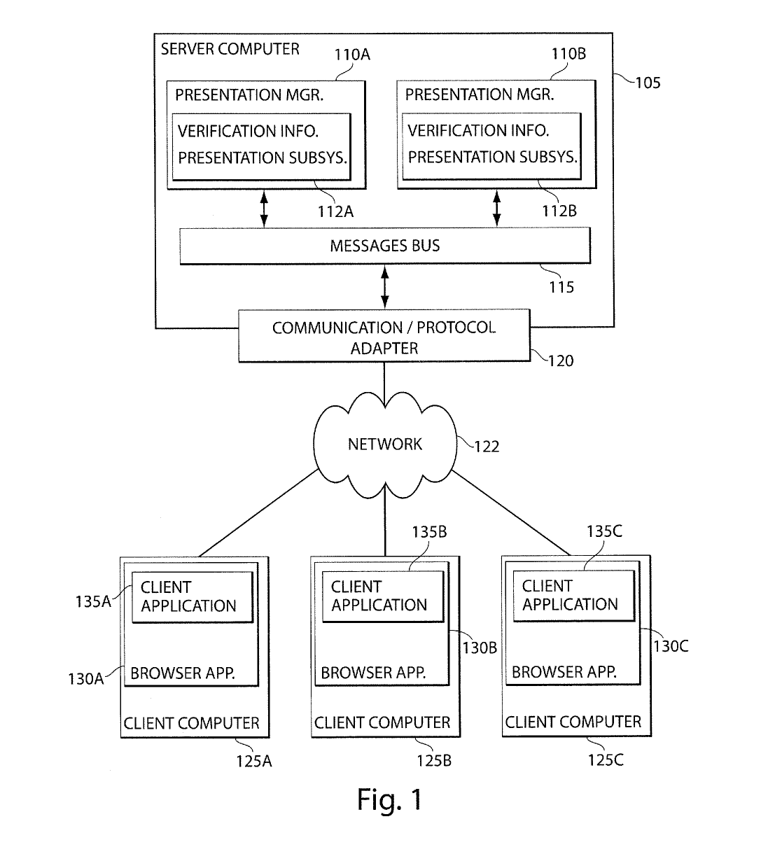

Some embodiments of the invention may be implemented in a computer system which includes at least one server computer, at least one client computer, and at least one network enabling communication between the server computer(s) and client computer(s). An example computer system 100 is shown in FIG. 1.

In example system 100, server computer 105 communicates with each of client computers 125A, 125B, 125C via network 122. Although FIG. 1 shows one server computer communicating with three client computers via one network, it should be appreciated that embodiments of the invention may be implemented in systems having any suitable number of server computers, client computers, networks and/or other components.

Server computer 105 executes presentation managers 110A and 110B, each of which may be implemented via software, hardware, or a combination thereof. For example, each of presentation managers 110A and 110B may comprise one or more program modules which deliver content comprising an online educational presentation to one or more of client computers 125. To this end, server computer 105 employs messages bus 115 and communication/protocol adapter 120 to communicate with each of client computers 125A, 125B and 125C via network 122. In some embodiments, communication/protocol adapter 120 may adapt data that is received from messages bus 115 for transport over network 122 via a particular communication protocol. For example, communication/protocol adapter 120 may adapt data for transport via the hypertext transport protocol (HTTP), via a custom socket-based version of transport control protocol/Internet protocol (TCP/IP), or via any other suitable communication protocol(s). Embodiments of the invention are not limited in this respect.

An online educational presentation may include a subset of client computers 125A-125C, or all of computers 125A-125C, with each client computer 125 having one or more associated attendees.

Although example system 100 includes two presentation managers 110 executing on server computer 105, it should be appreciated that embodiments of the invention are not limited to being implemented in this fashion. Any suitable number of presentation managers 110 may be deployed, executing on any suitable number of server computers. In addition, a presentation manager 110 need not execute on only a single server computer, and may be distributed across any suitable number of server computers.

In the example system 100, each presentation manager 110 includes a respective verification information presentation subsystem 112. Thus, presentation manager 110A includes verification information presentation subsystem 112A, and presentation manager 110B includes verification information presentation subsystem 112B. Of course, not all embodiments of the invention are limited to such an implementation, as a verification information presentation subsystem 112 may execute in support of any suitable number of presentation managers 110. For example, one verification information presentation subsystem 112 could execute in support of both of presentation managers 110A and 110B. Each verification information presentation subsystem 112 may be implemented via hardware, software, or a combination thereof. In some embodiments, each verification information presentation subsystem 112 may comprise program modules to deliver instructions defining the presentation of verification information to one or more client computers 125, and by extension to one or more attendees of an online educational presentation.

In example system 100, each client computer 125 executes a browser application 130 for displaying information sent from server computer 105 to a user. However, it should be appreciated that embodiments of the invention are not limited to being implemented with a browser application, as any suitable application(s) may be used to view and/or process the content of an online educational presentation. For example, a native application, executing on a client computer 125, which is configured to process and/or display presentation content received via a network may alternatively be used.

In the example implementation shown in FIG. 1, each client computer 125 executes a client application 135 which is “hosted by” (i.e., executes under the control of) browser application 135. Thus, client computer 125A executes browser application 130A and hosted client application 135A, client computer 125B executes browser application 130B and hosted client application 135B, and client computer 125C executes browser application 130C and hosted client application 135C. In some embodiments, a client application 135 may include program modules written in Javascript, although any suitable language(s) may be employed. A browser application 130 may comprise any browser application suitable for receiving, processing and displaying information received via a network, whether now known or later developed.

In accordance with some embodiments of the invention, server computer 105 and each client computer 125 employ a variation on the HTTP protocol to perform bi-directional, asynchronous communication. Those skilled in the art will recognize that HTTP does not conventionally support bi-directional, asynchronous communication. In this respect, HTTP is a stateless protocol, meaning that a communication channel is opened between a client computer and server computer when the client computer requests information from the server computer, and then closed when the server computer responds to the client computer with the requested information. That is, HTTP does not provide for a communication channel persisting across multiple requests sent by a client computer to a server computer, and does not provide a mechanism by which a server computer may send information to a client computer which the client computer has not requested.

In some embodiments of the invention, however, server computer 105 may send verification information to a client computer without the client computer having requested the information. This may be performed in any of various ways. For example, variations on the HTTP protocol may be employed which enable a communication channel, once opened between a client computer and server computer, to be held open so that the server computer may send instructions to the client computer defining the presentation of verification information. For example, after a request by a client computer causes a communication channel to be opened, the server computer to which the request was sent may take various types of actions to hold the communication channel open for an extended interval, allowing it to send instructions defining the presentation of verification information to the client computer. These instructions may be processed by the client computer to present the verification information to one or more users of the client computer.

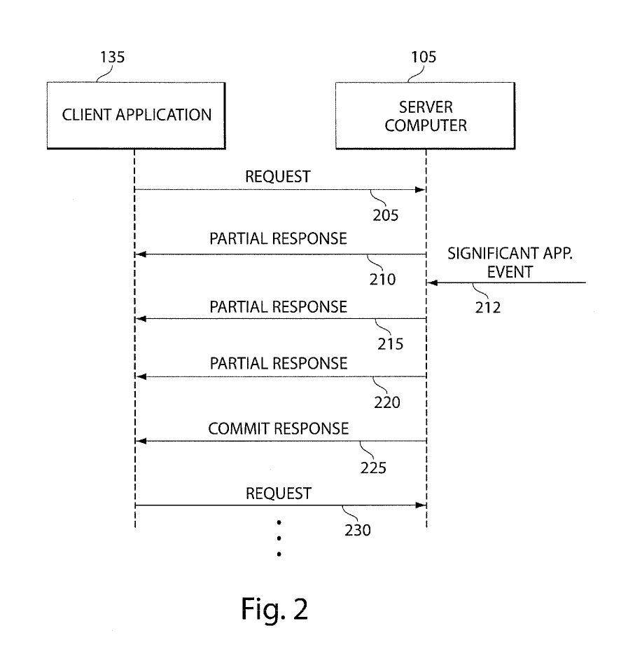

One example technique employing a variation on the HTTP protocol is shown in FIG. 2. Specifically, FIG. 2 is a time-sequence diagram showing an example process 200 involving communication between client application 135 executing on client computer 125 and one or more components on server computer 105. The component(s) may, for example, include presentation manager 110, communication/protocol adapter 120, and/or any other suitable component(s).

At the start of example process 200, client application 235 sends a request for information to server computer 105, thereby opening a communication channel, in act 205. This may be performed in any suitable fashion, such as by sending an HTTP (e.g., GET) request, as is known in the art.

In example process 200, rather than responding to the request, server computer 105 takes action to hold the communication channel open so that verification information may later be sent to the client computer, if appropriate. Specifically, in example process 200, rather than responding to client application 135 with the requested information, server computer 105 sends a “partial” response in act 210, which causes the communication channel to be held open while the client application awaits a “full” response with the information requested in act 205. A partial response may take any of numerous forms. For example, server computer 105 (e.g., communication/protocol adapter 120) may send a “heartbeat” or “ping” message to client application 135. This type of message may provide no substantive response to the request sent in act 205, but keeps the communication channel open.

Any suitable number of partial responses may be sent by server computer 105 to client application 135 to hold a communication channel open, and the partial responses may be sent at any suitable periodicity. Those skilled in the networking arts will recognize, however, that a communication channel can only be held open for so long without a full response being sent before a “timeout” occurs. When a timeout occurs may be defined by any one or more system components, including the browser application executing on the client computer, one or more networking components (e.g., a firewall, proxy server, etc.), and/or other system component.

In the example process 200, a significant application event occurs (as indicated at 212) after server computer 105 sends the partial response in act 210. A significant application event may comprise any suitable occurrence. For example, verification information presentation subsystem 112 (FIG. 1) may determine that the time for presenting verification information to an attendee of an online educational presentation has arrived, and so verification information presentation subsystem 112 may cause presentation manager 110 and server computer 105 to send instructions defining the presentation of the verification information to client application 135. In the example process 200 shown, the instructions are included in a partial response sent to client application 135 in act 215.

Instructions may be included in a partial response in any suitable way. For example, instructions may be included as payload in a partial response, such as in the form of a JavaScript Object Notation (JSON) object. However, it should be appreciated that any of numerous other forms and/or delivery techniques may alternatively be employed. It should also be appreciated that instructions need not be included in a single message, and may be distributed across any suitable number of messages.

In example process 200, server computer 105 sends another partial response in act 220. This may be performed, for example, to continue to hold open the communication channel, such as to allow for additional instructions to be sent to client application 135, and/or other information. Any suitable number of partial responses may be sent during the pendency of a communication channel.

In act 225, server computer 105 sends a full “commit” response to client application 135, providing the information requested in act 205, and closing the communication channel. In some embodiments, a commit response may be sent because it has been determined that a communication channel has been held open for close to the timeout period, or to close the communication channel for any other suitable reason.

In act 230, client application 235 issues a new request to server computer 105, causing a new communication channel to be opened and creating an opportunity for server computer 105 to send additional information to client application 135. As a result, acts similar to those described above may be executed. Example process 200 then ends.

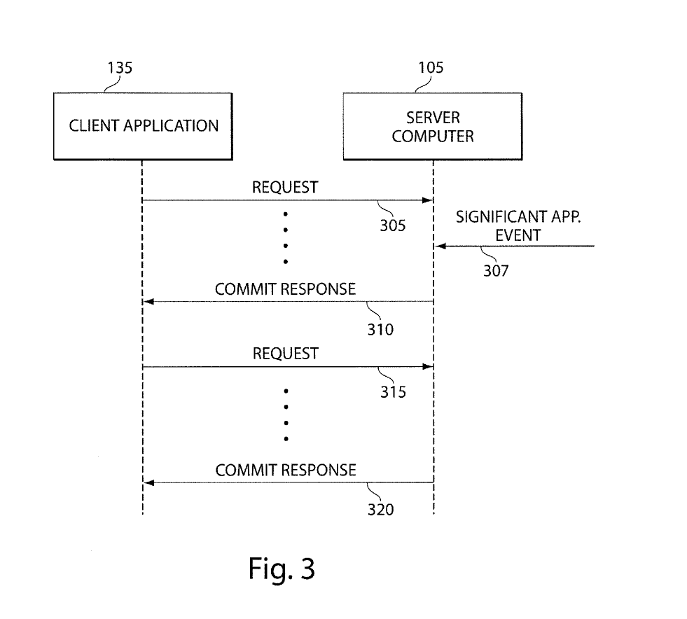

Another example process 300, representing another variation on the HTTP protocol, is shown in FIG. 3. In this variation, instead of server computer 105 issuing one or more partial responses to client application 135 hold open a communication channel, server computer 105 instead delays in sending a response, so as to hold the communication channel open during the delay.

At the start of example process 300, client application 235 sends a request to server computer 105 in act 305. Rather than responding immediately, server computer 105 delays in responding. In some embodiments, this delay may be for a predetermined period, which may range from, for example, tens of seconds to several minutes. Factors defining the length of the delay period may, for example, include how long it is believed that components on the system (e.g., firewalls, proxy servers, etc.) will allow a communication channel to be held open in the absence of communication between the client and server, and/or other factors.

A significant application event then occurs, as indicated at 307. As noted above, a significant application event may comprise any suitable occurrence, such as verification information presentation subsystem 112 (FIG. 1) determining that the time for presenting verification information to an attendee of an online educational presentation has arrived, and instructing presentation manager 110 and server computer 105 to send instructions to client application 135 to present the verification information. In example process 300, these instructions are included in a commit response sent to client application 135 in act 310.

In example process 300, the commit response sent in act 310 causes the communication channel between server computer 105 and client application 135 to be closed. To open a new communication channel and provide the ability for additional information to be sent to client application 135, a second request is sent by client application 135 in act 415. Server computer 105 may then delay in responding to this request as well, so as to provide a window during which a significant application event may occur, if appropriate. This communication channel is then closed via the issuance of a commit response in act 320, and example process 300 then ends.

It should be appreciated that example processes 200 and 300 represent only two possible ways that variations on the HTTP protocol may be used to send instructions from presentation manager 110 to client application 135, and that numerous other variations are possible. It should also be appreciated that embodiments of the invention are not limited to employing one variation, but not the other. Indeed, in some embodiments of the invention, example system 100 (FIG. 1) may be configured to enable switching between one mode employing one variation and another mode employing another variation. For example, in some embodiments, one mode employing a particular variation may be selected for use during an initial “handshake” between server computer 105 and a client computer 125, based on any of numerous factors (e.g., components used in the system, whether HTTP content is buffered during transport (e.g., by a third party proxy server), and/or other factors), and then at some point during operation the system may switch to another mode, based on any of numerous factors (e.g., a change in network conditions, etc.). For example, example process 300 may constitute a “fallback” process which is performed if example process 200 can not be, for any of numerous reasons.

Further, timing parameters associated with either of the variations described above may be adjusted dynamically during operation, for any of various reasons. For example, if the variation represented by example process 200 is used, timing parameters affecting how frequently partial responses are sent from presentation manager 110 to client application 135 may be adjusted based on, for example, observed network conditions. Embodiments of the invention may be implemented in any of numerous ways.

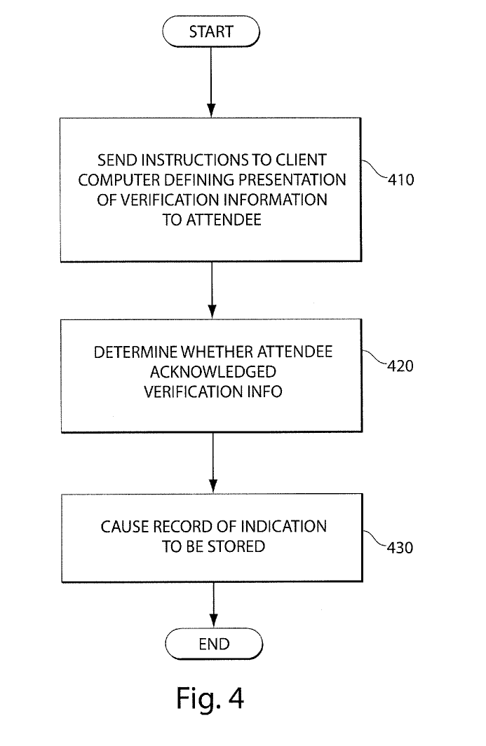

FIG. 4 depicts an example process 400 by which a server computer determines whether a user of a client computer has acknowledged verification information presented to him/her. At the start of example process 400, in act 410, server computer 105 sends instructions to client computer 125 defining the presentation of verification information to an attendee of an online educational presentation. The instructions may be sent, for example, using either of the example processes described above with reference to FIG. 2 or 3, and/or using other techniques.

Instructions defining the presentation of verification information may include any suitable information. For example, the instructions may specify the verification information that is to be presented (e.g., if one or more codes are to be presented, then the instructions may specify the codes, or a manner of determining or generating the codes), the manner in which the verification information is to be presented (e.g., in a “pop up” box, using another suitable mechanism, etc.), the way(s) that the attendee may acknowledge the verification information (e.g., by re-typing it into an input box provided for that purpose, by clicking a link to “submit” a code input field which has been pre-populated with the verification information, and/or using any other suitable technique), the time at which the verification information is to be shown (e.g., the periodicity between presentations and/or a manner of determining such periodicity), how long the verification information is to be presented for acknowledgement before disappearing from the attendee's screen, and/or any other suitable information.

Example process 400 then proceeds to act 420, wherein server computer 105 determines whether the verification information was acknowledged by the attendee. This may be performed in any of numerous ways. In one example, act 120 may involve presentation manager 110 determining based on a lack of an acknowledgement received from client application 235 that an attendee did not acknowledge verification information that was presented to him/her within a specified time interval. In another example, presentation manager may receive an indication from client application 235 that an attendee of an online educational presentation did not acknowledge verification information within a specified time interval. Any suitable technique for determining whether information was acknowledged by an attendee may be performed, as embodiments of the invention are not limited in this respect.

Example process 400 then proceeds to act 430, wherein server computer 105 causes a record of the determination to be stored, such as in electronic file storage (which may or may not reside on server 205 or client 125). Example process 400 then completes.

It should be appreciated that each of the example processes described above with reference to FIGS. 2-4 represents only an example manner in which some embodiments of the invention may be implemented. Numerous variations on these example processes are possible. For example, any of the individual acts described above may be performed in a different manner than that which is described, the acts may be performed in a different sequence than that which is described above, any of the acts may be omitted or replaced by other acts not described above, and/or other acts not described above may be performed in addition to the described acts. Embodiments of the invention are not limited to any particular manner of implementation.

In some embodiments, techniques may be provided for temporarily suspending and/or pausing the presentation of verification information to attendees during specified periods. In this respect, the inventors have appreciated that during some online educational presentations, breaks may be offered to attendees (e.g., during extended presentations), and that presenting verification information for acknowledgement during a break would be ineffective. As such, some embodiments of the invention enable presentation of verification information to be suspended during breaks. This may be accomplished in any of numerous ways. For example, programmed logic may define the suspension or cessation of information presentation during breaks, while preserving timing rules defined for non-break periods.

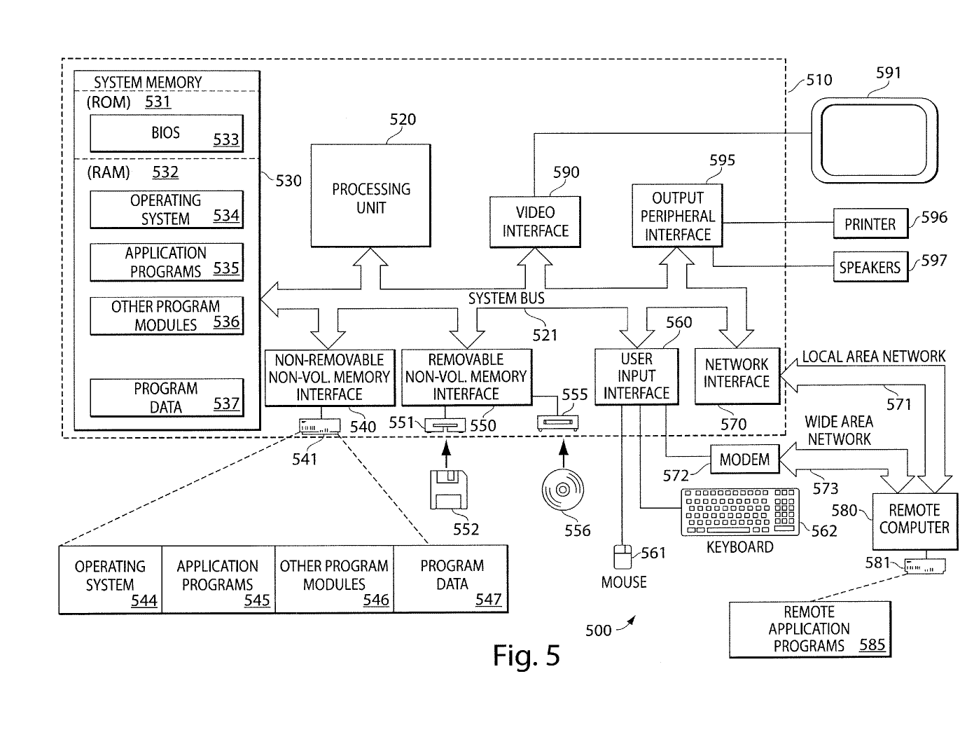

FIG. 5 illustrates one example of a suitable computing system environment 500 with which aspects of the invention may be implemented. The computing system environment 500 is only one example of a suitable computing environment, and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 5, an example system for implementing the invention includes a general purpose computing device in the form of a computer 510. Components of computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through an non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 510 through input devices such as a keyboard 562 and pointing device 561, commonly referred to as a mouse, trackball or touch pad. Other input devices (not shown) may include a microphone, joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. In addition to the monitor, computers may also include other peripheral output devices such as speakers 597 and printer 596, which may be connected through a output peripheral interface 595.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on memory device 581. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for determining whether an attendee views content included in an online educational presentation, the method being for use in a computer system comprising at least one server computer, a client computer, and at least one network enabling communication between the at least one server computer and the client computer, the method comprising acts of:
(A) sending, by the at least one server computer to the client computer, at least one instruction defining presentation by the client computer of verification information to be acknowledged by the attendee during the online educational presentation;
(B) determining, by the at least one server computer, whether the verification information was acknowledged by the attendee; and
(C) causing, by the server computer, a record of the determination to be stored.

2. The method of claim 1, wherein the at least one instruction sent in the act (A) specifies the verification information or a manner of determining the verification information.

3. The method of claim 1, wherein the at least one instruction sent in the act (A) specifies a manner of acknowledging the verification information by the attendee.

4. The method of claim 1, wherein the at least one instruction sent in the act (A) specifies a time interval for presentation of the verification information to the attendee.

5. The method of claim 1, wherein the act (A) is performed subsequent to a hypertext transfer protocol request being received from the client computer.

6. The method of claim 1, wherein the act (A) comprises including the at least one instruction in a response to the client computer which closes a communication channel between the at least one server computer and the client computer.

7. The method of claim 1, wherein the act (A) comprises including the at least one instruction in a partial response to the client computer which holds open a communication channel between the at least one server computer and the client computer.

8. The method of claim 1, further comprising an act, performed prior to the act (A), of determining, by the at least one server computer, a time interval during which verification information is not to be presented to the attendee.

9. The method of claim 1, wherein the act (B) comprises the at least one server computer receiving from the client computer an indication whether the verification information was acknowledged by the attendee.

10. At least one computer-readable medium having instructions recorded thereon which, when executed in a computer system comprising at least one server computer, a client computer, and at least one network enabling communication between the at least one server computer and the client computer, perform a method for determining whether an attendee views content included in an online educational presentation, the method comprising acts of:
(A) sending, by the at least one server computer to the client computer, at least one instruction defining presentation by the client computer of verification information to be acknowledged by the attendee during the online educational presentation;
(B) determining, by the at least one server computer, whether the verification information was acknowledged by the attendee; and
(C) causing, by the server computer, a record of the determination to be stored.

11. The at least one computer-readable medium of claim 10, wherein the at least one instruction sent in the act (A) specifies the verification information or a manner of determining the verification information.

12. The at least one computer-readable medium of claim 10, wherein the at least one instruction sent in the act (A) specifies a manner of acknowledging the verification information by the attendee.

13. The at least one computer-readable medium of claim 10, wherein the at least one instruction sent in the act (A) specifies a time interval for presentation of the verification information to the attendee.

14. The at least one computer-readable medium of claim 10, wherein the act (A) is performed subsequent to a hypertext transfer protocol request being received from the client computer.

15. The at least one computer-readable medium of claim 10, wherein the act (A) comprises including the at least one instruction in a response to the client computer which closes a communication channel between the at least one server computer and the client computer.

16. The at least one computer-readable medium of claim 10, wherein the act (A) comprises including the at least one instruction in a partial response to the client computer which holds open a communication channel between the at least one server computer and the client computer.

17. The at least one computer-readable medium of claim 10, wherein the method further comprises an act, performed prior to the act (A), comprising determining, by the at least one server computer, a time interval during which verification information is not to be presented to the attendee.

18. The at least one computer-readable medium of claim 10, wherein the act (B) comprises the at least one server computer receiving from the client computer an indication whether the verification information was acknowledged by the attendee.

19. A system for determining whether an attendee views content included in an online educational presentation, the system comprising:
at least one server computer, having at least one processor programmed to:
send, via at least one network to a client computer, at least one instruction defining presentation by the client computer of verification information to be acknowledged by the attendee during the online educational presentation;
determine whether the verification information was acknowledged by the attendee; and
cause a record of the indication to be stored.

20. The system of claim 19, wherein the at least one instruction specifies the verification information or a manner of determining the verification information.

21. The system of claim 19, wherein the at least one instruction specifies a manner of acknowledging the verification information by the attendee.

22. The system of claim 19, wherein the at least one instruction specifies a time interval for presentation of the verification information to the attendee.

23. The system of claim 19, wherein the at least one processor is programmed to send the at least one instruction subsequent to a hypertext transfer protocol request being received from the client computer.

24. The system of claim 19, wherein the at least one processor is programmed to include the at least one instruction in a response to the client computer which closes a communication channel between the at least one server computer and the client computer.

25. The system of claim 19, wherein the at least one processor is programmed to include the at least one instruction in a partial response to the client computer which holds open a communication channel between the at least one server computer and the client computer.

26. The system of claim 19, wherein the at least one processor is programmed to determine a time interval during which verification information is not to be presented to the attendee.

27. The system of claim 19, wherein the at least one processor is programmed to receive an indication whether the verification information was acknowledged by the attendee.
